(19) United States
(12) Patent Application Publication
(10) Pub. No.: US 2023/0111774 A1
(43) Pub. Date: Apr. 13, 2023

(54) SOLID ELECTROLYTE, ELECTRICITY STORAGE DEVICE AND METHOD FOR PRODUCING SOLID ELECTROLYTE

(71) Applicant: Nippon Chemi-Con Corporation, Shinagawa-ku, Tokyo (JP)

(72) Inventors: Shun KOIKAWA, Kanagawa (JP); Yasuyoshi SHIRAISHI, Kanagawa (JP); Satoshi KUBOTA, Tokyo (JP); Shuichi ISHIMOTO, Kanagawa (JP)

(21) Appl. No.: 17/907,964

(22) PCT Filed: Mar. 5, 2021
(86) PCT No.: PCT/JP2021/008767

§ 371 Date: Aug. 29, 2022

(30) Foreign Application Priority Data
Mar. 9, 2020 (JP) 2020-040215

(51) Int. Cl. H01M 10/0565; H01M 4/04; H01M 10/0525

(52) U.S. Cl. CPC H01M 10/0565; H01M 4/0404; H01M 10/0525; H01M 2300/0082

(57) ABSTRACT

Provided are plastic crystal-type solid electrolyte having high ion conductivity and a power storage device using the solid electrolyte. The solid electrolyte contains a plastic crystal doped with an electrolyte. The plastic crystal contains two or more types of cations in total, at least one of which is selected from the group of imidazoliums and quaternary ammoniums.

### FIELD OF INVENTION

The present disclosure relates to a solid electrolyte containing a plastic crystal, a power storage device using this solid electrolyte, and a method of manufacturing this solid electrolyte.

### BACKGROUND

Secondary batteries, electric double-layer capacitors, fuel cells, solar cells, and other power storage devices are schematically constituted with positive and negative electrodes disposed opposite to each other with an electrolyte layer sandwiched therebetween. A lithium-ion secondary battery has a Faraday reaction electrode, and reversibly inserts and releases lithium ions in the electrolyte layer with the electrodes to charge and discharge electrical energy. The electric-double layer capacitor, which has one or both electrodes being polarizable electrodes, utilizes a power storage function of an electric double layer formed on an interface between the polarizable electrode and the electrolyte layer to perform charge and discharge.

As the electrolyte layer in the powder storage device, a solid electrolyte layer can be selected. The solid electrolyte layer limits a region of a chemical reaction of the electrode, such as hydrolytic deterioration, to a proximity of the electrode. Thus, the solid electrolyte layer reduces leakage current and inhibits self-discharge compared with an electrolyte liquid. Compared with the electrolyte liquid, the solid electrolyte layer also reduces a generation amount of gas derived from the chemical reaction with the electrode to reduce risks of vent opening and liquid leakage.

Known solid electrolytes include: sulfide-type solid electrolytes such as Li₂S.P₂S₅; oxide-type solid electrolytes such as Li₇La₃Zr₂O₁₂; plastic crystal-type solid electrolyte having, for example, N-ethyl-N-methylpyrrolidinium (P12) as a cation and bis(fluorosulfonyl)amide (FSA) as an anion; and polymer-type solid electrolytes such as polyethylene glycol. In the secondary battery, a selected matrix phase is doped with lithium ions as an electrolyte, if necessary. In the electric-double layer capacitor, a selected matrix phase is doped with, for example TEMABF4, as an electrolyte, if necessary.

The plastic crystal is soluble in an organic solvent. Meanwhile, the sulfide- and oxide-type solid electrolytes are insoluble. Accordingly, when the plastic crystal is used as the solid electrolyte or a matrix phase of the solid electrolyte, a usable manufacturing method is a method in which an anionic component and cationic component, or their salt of the plastic crystal are dissolved in a solvent to be applied on the electrode. Thus, compared with the sulfide- and oxide-type solid electrolytes, the plastic crystal-type solid electrolyte has an advantage of increase in adhesiveness to the electrode and, when an active material phase of the electrode is a porous structure, easy permeation into the structure.

### PRIOR ART DOCUMENT

### Patent Document

Patent Literature 1: National Publication of International Patent Application No. 2014-504788
Patent Literature 2: Japanese Patent Laid-Open No.

### SUMMARY OF INVENTION

### Problems to be Solved by Invention

However, pointed out with the plastic crystal-type solid electrolyte is low ion conductivity over two to three orders compared with the sulfide- and oxide-type solid electrolytes. For example, a solid electrolyte containing a plastic crystal composed of an N,N-diethylpyrrolidinium cation and a bis(fluorosulfonyl)amide anion is reported to have an ion conductivity of 1×10⁻⁵ S/cm order under an environment at 25° C. A solid electrolyte containing a plastic crystal composed of an N,N-dimethylpyrrolidinium cation and a bis(trifluoromethanesulfonyl)amide anion is reported to have an ion conductivity of 1×10⁻⁸ S/cm order.

In contrast, for example, the solid electrolyte of Li₂S.P₂S₅ is reported to have an ion conductivity of 1×10⁻² S/cm order. For example, the solid electrolyte of Li₇La₃Zr₂O₁₂ is reported to have an ion conductivity of 1×10⁻³ S/cm order.

The present invention is proposed to solve the above problem, and an object thereof is to provide a plastic crystal-type solid electrolyte having high ion conductivity and a power storage device using the solid electrolyte.

### Means to Solve the Problem

The present inventors have made intensive investigation, and as a result, have found that use of a combination of two types of cations in total, the essential component being a specific cation that can constitute a plastic crystal, increases ion conductivity of a solid electrolyte compared with a case where the cation is used alone. It has also been found that use of an imidazolium cation as one of the two types of cations remarkably increases the ion conductivity of the solid electrolyte. In addition, it has been found that use of a combination of two types of anions that can constitute a plastic crystal also increases the ion conductivity of a solid electrolyte compared with a case where the anion is used alone.

The present invention has been made based on this finding, and to solve the above problem, a solid electrolyte according to the present invention comprises a plastic crystal doped with an electrolyte, wherein the plastic crystal contains two or more types of cations in total, at least one of which is selected from the group of imidazoliums and quaternary ammoniums.

The present invention has been made based on this finding, and the plastic crystal may contain two or more types of anions. For example, the plastic crystal may contain two or more types of anions in total selected from the group of amide anions in which two hydrogen atoms of an NH₂ anion are substituted with a perfluoroalkylsulfonyl group, a fluorosulfonyl group, or both of them, and a tris(trifluoromethanesulfonyl)methanide anion.

The present invention has been made based on this finding, and the plastic crystal may contain: two types of cations selected from the group of the quaternary ammoniums; two types of cations selected from the group of the imidazoliums; one type of cation selected from the group of the imidazoliums and one type of cation selected from the group of the quaternary ammoniums; one type of cation each selected from the group of the imidazoliums and the group of the quaternary ammoniums; or one type of cation selected from the group of imidazoliums and quaternary ammoniums, and another type of cation excluding the imidazoliums and the quaternary ammoniums.

The one type of cation selected from the group of the imidazoliums is a 1,3-dimethylimidazolium cation, a 1-ethyl-3-methylimidazolium cation, a 1-methyl propylimidazolium cation, or an imidazolium in which these cations are substituted with a methyl group at the 2-position. The plastic crystal preferably contains an N,N-hexafluoro-1,3-disulfonylamide anion as an anion with the one type of cation selected from the group of the imidazoliums.

The one type of cation selected from the group of the imidazoliums is 1,3-dimethylimidazolium or 1-ethyl-3-methylimidazolium. The plastic crystal preferably contains, as an anion with the one type of cation selected from the group of the imidazoliums, a perfluoroalkylsulfonate anion in which a hydrocarbon group extending from the sulfonate skeleton is substituted with a perfluoroalkyl group.

Combination of these anions and the imidazolium facilitates the synthesis of the plastic crystal, and improves the increase in the ion conductivity of this plastic crystal.

A power storage device using this solid electrolyte is also an aspect of the present invention.

A method of manufacturing a solid electrolyte according to the present invention has been made based on this finding, and to solve the above problem, the method comprises a step of producing a plastic crystal containing two types of cations selected from the group of pyrrolidiniums, imidazoliums, quaternary ammoniums, and phosphoniums.

### Effect of Invention

The present invention increases the ion conductivity of the solid electrolyte using the plastic crystal.

### EMBODIMENTS

Hereinafter, embodiments of the present invention will be described. The present invention is not limited to the embodiments described below.

(Solid Electrolyte)

The solid electrolyte is interposed between positive and negative electrodes of a power storage device to conduct mainly ions. The power storage device, which is a passive element charging and discharging electrical energy, is, for example, a lithium-ion secondary battery, an electric double-layer capacitor, and the like. The Lithium-ion secondary battery has a Faraday reaction electrode, and reversibly inserts and releases lithium ions in the electrolyte layer with the electrodes to charge and discharge electrical energy. The electric-double layer capacitor, which has one or both electrodes being polarizable electrodes, utilizes a power storage function of an electric double layer formed on an interface between the electrode and the electrolyte layer to perform charge and discharge.

This solid electrolyte has a matrix phase formed of the plastic crystal to be an ion-conductive medium, and contains, as an electrolyte, an ionic salt with which the plastic crystal is doped. The plastic crystal has an ordered arrangement and a disordered arrangement. That is, the plastic crystal has a three-dimensional crystal lattice structure in which anions and cations are regularly arranged, and meanwhile, these anions and cations have rotation irregularity. In the plastic crystal, positive ions and negative ions generated by dissociation of the electrolyte hop with rotation of the anions and cations to move through gaps in the crystal lattice.

(Plastic Crystal Cation)

The plastic crystal is constituted with at least two types of cations. At least one of the cations of the plastic crystal is selected from the group of imidazoliums and quaternary ammoniums. That is, the plastic crystal contains: two different imidazoliums; two different quaternary ammoniums; one imidazolium and one quaternary ammonium; one imidazolium and another cation; or one quaternary ammonium and another cation. Examples of the other cation include phosphoniums.

The imidazolium has a five-membered ring having nitrogen atoms at the 1-position and the 3-position. In the five-membered ring, which is a cyclic conjugated system, the π-electrons are delocalized to reduce a surface charge density, resulting in a reduced apparent charge amount q. Thus, a Coulomb force with the cation constituting the plastic crystal decreases. This imidazolium is substituted with an alkyl group at the 1-position and 3-position. This alkyl group distances itself from the anion to reduce a Coulomb force generated between this imidazolium and the anion.

This configuration reduces the interaction relationship between the imidazolium and the anion to increase a degree of rotation freedom of the imidazolium and the anion. Thus, the imidazolium is preferably selected since improvement in the ion conductivity is particularly expected.

These imidazoliums are a 1,3-dialkylimidazolium or a 1,2,3-trialkylimidazolium represented by the following chemical formula (A).

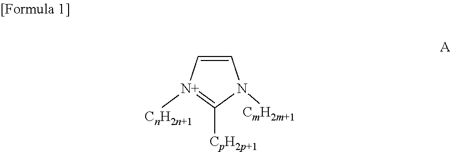

In the formula, n and m represent integers of 1 or more and 3 or less, and p represents 0 or 1.

When p represents 0 and n and m represent 1 in the chemical formula (A), the imidazolium is 1,3-dimethylimidazolium (DMI) represented by the following chemical formula (A1). This DMI may be substituted with a methyl group at the 2-position.

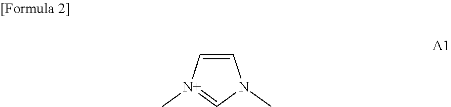

When p represents 0, n represents 1, and m represents 2 in the chemical formula (A), the imidazolium is 1-ethyl-3-methylimidazolium (EMI) represented by the following chemical formula (A2). This EMI may be substituted with a methyl group at the 2-position.

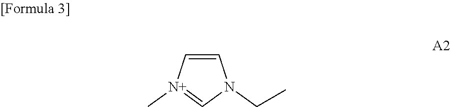

When p represents 0, n represents 1, and m represents 3 in the chemical formula (A), the imidazolium is 1-methyl-3-propylimidazolium (MPI) represented by the following chemical formula (A3). This MPI may be substituted with a methyl group at the 2-position.

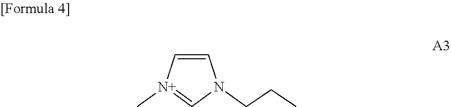

Examples of the quaternary ammoniums include a tetraalkylammonium represented by the following chemical formula (B) and substituted with a linear alkyl group having any number of carbon atoms. When a, b, and c represent 2, and d represents 1 in the following chemical formula (B), the quaternary ammonium is triethylmethylammonium (TEMA).

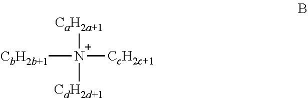

In the formula, a, b, c, and d represent integers of 1 or more, and the number of carbon atoms may be any number.

Examples of the quaternary ammonium include a pyrrolidinium, which has a five-membered ring, represented by the following chemical formula (C) and in which a methyl group, an ethyl group, or an isopropyl group is bonded.

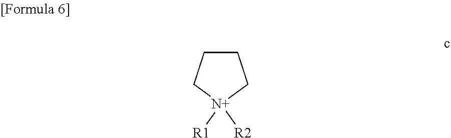

In the formula, R1 and R2 represent a methyl group, an ethyl group, or an isopropyl group.

Specific examples of the pyrrolidinium, which has a five-membered ring, generalized by the chemical formula (C) include N-ethyl-N-methylpyrrolidinium (P12) represented by the following chemical formula (C1), N-isopropyl-N-methylpyrrolidinium (P13iso) represented by the following chemical formula (C2), and N,N-diethylpyrrolidinium (P22) represented by the following chemical formula (C3).

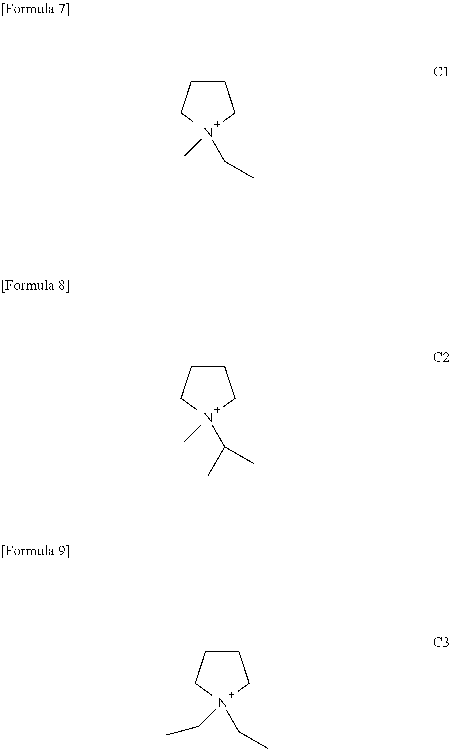

Examples of the quaternary ammonium also include spiro-pyrrolidinium (SBP) represented by the following chemical formula (D).

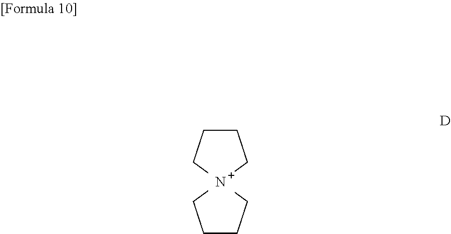

Examples of the phosphoniums as the other cation include a tetraalkylphosphonium represented by the following chemical formula (E) and substituted with a linear alkyl group having any number of carbon atoms. Examples of the tetraalkylphosphonium include a tetraethylphosphonium cation (TEP).

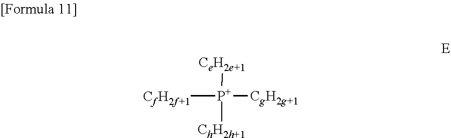

In the formula, e, f, g, and h represent integers of 1 or more, and the number of carbon atoms may be any number.

Although not limited to the following mechanism, it is presumed that mixing the two types of cations changes the crystal structure relative to a plastic crystal containing one type of cation, and this change facilitates the hopping of the positive ions and the negative ions in the electrolyte to increase the ion conductivity of the solid electrolyte.

It is to be noted that the ion conductivity of the solid electrolyte is increased by not simply mixing the two types of cations but by changing the crystal structure of the plastic crystal constituted with the imidazoliums alone represented by the chemical formula (A) due to containing the other cation. The ion conductivity of the solid electrolyte is increased by changing the crystal structure of the plastic crystal constituted with the quaternary ammonium alone represented by the chemical formula (B) due to the contained other cation.

When a mixing ratio of the two types is within a range of 10:90 to 90:10 in a molar ratio, in other words, a mixing ratio of the two types is within a range of 10 mol % or more and 90 mol % of one type relative to a total number of moles of the cations constituting the plastic crystal, the ion conductivity of the solid electrolyte remarkably increases. In particular, when the mixing ratio of the two types is within a range of 20:80 to 80:20 in a molar ratio, in other words, the mixing ratio of the two types is within a range of 20 mol % or more and 80 mol % of one type relative to a total number of moles of the cations constituting the plastic crystal, the ion conductivity of the solid electrolyte further remarkably increases.

An anion constituting the plastic crystal may be any known anions as long as it does not form an ionic liquid and can maintain the solid state to constitute the plastic crystal within a temperature range of use of the power storage device. Also, two or more types of anions may be selected. The imidazolium is a cation constituting an ionic liquid within a temperature range including a room temperature, and when this imidazolium is selected, a specific type of anion is selected as the anion to constitute the plastic crystal.

(Plastic Crystal Anion)

Examples of the anion include: amide anions; a tris(trifluoromethanesulfonyl)methanide anion; a hexafluorophosphate anion (PF₆ anion); perfluoroalkylphosphate anions in which some fluorine atoms in PF₆ are substituted with fluoroalkyl groups; perfluoroalkylborate anions in which some fluorine atoms in a BF₄ anion are substituted with fluoroalkyl groups; and perfluoroalkylsulfonate anions (NFS anions) in which a hydrocarbon group extending from the sulfonate skeleton is substituted with a perfluoroalkyl group.

In the amide anions, two hydrogen atoms of an NH₂ anion are substituted with a perfluoroalkylsulfonyl group, a fluorosulfonyl group, or both of them. Examples of the amide anions include linear anions, and include bis(perfluoroalkylsulfonyl)amide anions, a bis(fluorosulfonyl)amide anion, and N-(fluorosulfonyl)-N-(perfluoroalkylsulfonyl)amide anions represented by the following chemical formula (F).

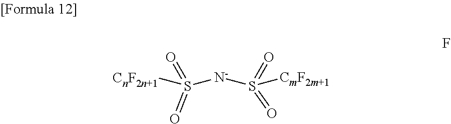

In the chemical formula (F), n and m represent integers of 0 or more, and the number of carbon atoms may be any number.

When n and m represent 1 or more in the chemical formula (F), the amide anion is a bis(perfluoroalkylsulfonyl)amide anion. Specific examples of the bis(perfluoroalkylsulfonyl)amide anion include a bis(trifluoromethanesulfonyl)amide anion (TFSA anion) represented by the following chemical formula (F1) and a bis(pentafluoroethylsulfonyl)amide anion (BETA anion) represented by the following chemical formula (F2).

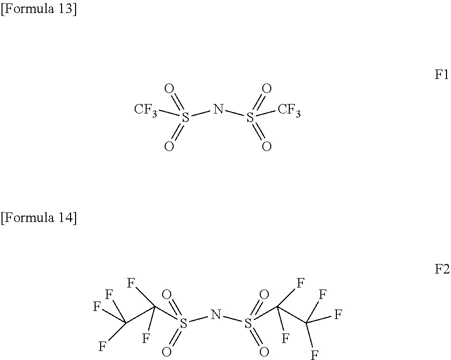 [SMILES: O=S(=O)(NS(=O)(=O)C(F)(F)F)C(F)(F)F ; O=S(=O)(NS(=O)(=O)C(F)(F)C(F)(F)F)C(F)(F)C(F)(F)F]

In the chemical formula (F), a group having 0 carbon atoms is a fluorosulfonyl group, and when n and m represent 0, the amide anion is a bis(fluorosulfonyl)amide anion (FSA anion) represented by the following chemical formula (F3).

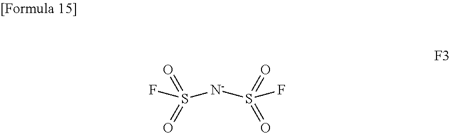

When n represents 0 and m represents 1 or more in the chemical formula (F), the amide anion is an N-(fluorosulfonyl)-N-(perfluoroalkylsulfonyl)amide anion represented by the following chemical formula (F4).

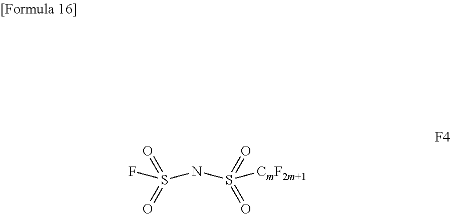

Examples of the amide anions also include five-membered and six-membered heterocyclic amide anions, and include an N,N-hexafluoro-1,3-disulfonylamide anion (CFSA anion) represented by the following chemical formula (G) and N,N-pentafluoro-1,3-disulfonylamide represented by the following chemical formula (H).

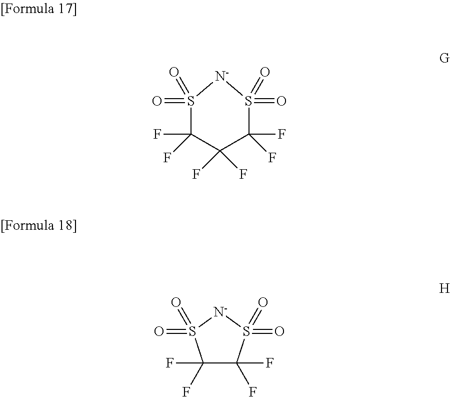 [SMILES: O=S1(=O)[N-]S(=O)(=O)C(F)(F)C(F)(F)C1(F)F ; O=S1(=O)[N-]S(=O)(=O)C(F)(F)C1(F)F]

The tris(trifluoromethanesulfonyl)methanide anion (TFSM anion) is represented by the following chemical formula (I).

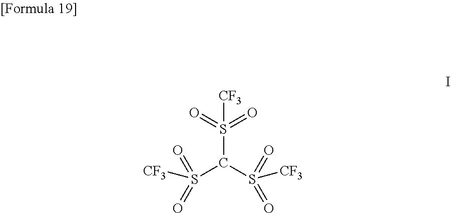 [SMILES: O=S(=O)(C(S(=O)(=O)C(F)(F)F)S(=O)(=O)C(F)(F)F)C(F)(F)F]

Examples of the perfluoroalkylphosphate anions in which some fluorine atoms in PF₆ are substituted with fluoroalkyl groups include a tris(fluoroalkyl)trifluorophosphate anion represented by the following chemical formula (J).

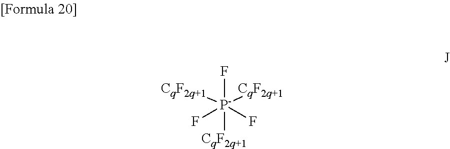

In the formula (J), q represents an integer of 1 or more, and the number of carbon atoms may be any number.

Specific examples thereof include a tris(pentafluoroethyl)trifluorophosphate anion (FAP anion) represented by the following chemical formula (J1).

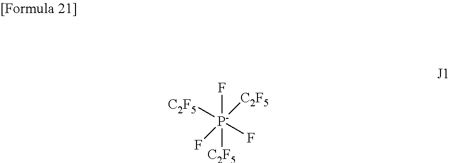

Examples of the perfluoroalkylborate anions include a mono(fluoroalkyl)trifluoroborate anion represented by the chemical formula (K), and a bis(fluoroalkyl)fluoroborate anion.

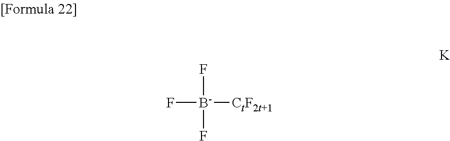

In the formula, s represents an integer of 0 or more, t represents an integer of 1 or more, and the number of carbon atoms may be any number.

When s represents 0 and t represents 1 or more in the chemical formula (K), the borate anion is a mono(fluoroalkyl)trifluoroborate anion represented by the following chemical formula (K1). Specific examples thereof include a mono(trifluoromethyl)trifluoroborate anion represented by the following chemical formula (K2).

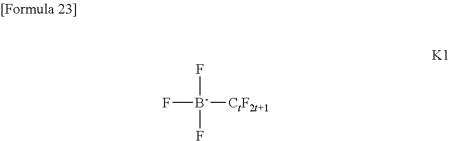

In the formula, t represents an integer of 1 or more, and the number of carbon atoms may be any number.

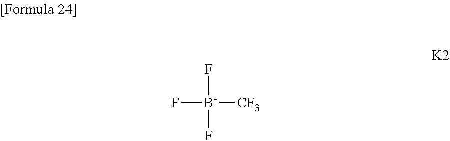

The perfluoroalkylsulfonate anions (NFS anion) are represented by the following chemical formula (L).

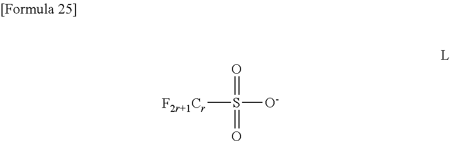

In the chemical formula (L), r represents an integer of 1 or more and 4 or less.

Specifically, the perfluoroalkylsulfonate anion is preferably a trifluoromethanesulfonate anion wherein r represents 1 in the following chemical formula (L), a pentafluoroethylsulfonate anion wherein r represents 2 in the following chemical formula (L), a heptafluoropropanesulfonate anion wherein r represents 3 in the following chemical formula (L), and a nonafluorobutanesulfonate anion wherein r represents 4 in the following chemical formula (L).

When the imidazolium is selected as the cation of the plastic crystal, an anion constituting the plastic crystal with this imidazolium is preferably the N,N-hexafluoro-1,3-disulfonylamide anion (CFSA anion) represented by the chemical formula (G) or the perfluoroalkylsulfonate anion (NFS anion) represented by the chemical formula (F) and in which a hydrocarbon group extending from the sulfonate skeleton is substituted with a perfluoroalkyl group.

The imidazolium is known as a cation to constitute an ionic liquid constituted with combination with a bis(trifluoromethanesulfonyl)amide anion, which is also referred to as a TFSA anion, and having a melting point of −3° C. With the imidazolium, increase or decrease in an apparent charge amount q and a Coulomb force due to the presence of an alkyl group is sensitive.

Meanwhile, the CFSA anion or the NFS anion when combined with N-ethyl-N-methylpyrrolidinium also referred to as a P12 cation to form P12CFSA, for example, constitutes a plastic crystal having a melting point of 302° C. That is, plastic crystals having these anions are considered to have a high melting point. Therefore, these anions are considered to act for raising a melting point of a salt having a low melting point and having a cation that easily forms an ionic liquid. Furthermore, it is considered that regulating the number of carbon atoms in a chain length of the alkyl group in the cation to 3 or less or 2 or less according to the anion enables to achieve a balance between formability of the plastic crystal and the increase in the ion conductivity.

As a result, the imidazolium combined with these anions constitutes a plastic crystal exhibiting further high ion conductivity.

Also, the present invention is not limited to use of one type of anion, and two types of anions may be combined. Using two types of anions increases the ion conductivity. Although not limited to the following mechanism, it is presumed that mixing two types changes the crystal structure relative to a plastic crystal having one type of anion, and this change facilitates the hopping of the anions and cations in the electrolyte to increase the ion conductivity of the solid electrolyte. Therefore, a mixing ratio of the two types may be any as long as the crystal structure changes compared with the single anion.

When a mixing ratio of the two types is within a range of 10:90 to 90:10 in a molar ratio, in other words, a mixing ratio of the two types is within a range of 10 mol % or more and 90 mol % of one type relative to a total number of moles of the anions constituting plastic crystal, the ion conductivity of the solid electrolyte remarkably increases. In particular, when the mixing ratio of the two types is within a range of 20:80 to 80:20 in a molar ratio, in other words, the mixing ratio of the two types is within a range of 20 mol % or more and 80 mol % of one type relative to a total number of moles of the anions constituting the plastic crystal, the ion conductivity of the solid electrolyte further remarkably increases.

(Electrolyte)

An ionic salt to be the electrolyte with which the plastic crystal is doped depends on a type of the power storage device. Examples of ionic salts for a lithium-ion secondary battery include Li(CF₃SO₂)₂N (commonly referred to as LiTFSA), Li(FSO₂)₂N (commonly referred to as LiFSA), Li(C₂F₅SO₂)₂N, LiPF₆, LiBF₄, LiAsF₆, LiTaF₆, LiClO₄, and LiCF₃SO₃, and used singly or in combination of two or more thereof. Ionic salts for an electric double-layer capacitor are a salt of an organic acid, a salt of an inorganic acid, or a salt of a composite compound between an organic acid and an inorganic acid, and used singly or in combination of two or more thereof.

Examples of the organic acid include: carboxylic acids such as oxalic acid, succinic acid, glutaric acid, pimelic acid, suberic acid, sebacic acid, phthalic acid, isophthalic acid, terephthalic acid, maleic acid, adipic acid, benzoic acid, toluic acid, enanthic acid, malonic acid, 1,6-decanedicarboxylic acid, 1,7-octanedicarboxylic acid, azelaic acid, undecanedioic acid, dodecanedioic acid, and tridecanedioic acid; phenols; and sulfonic acids. Examples of the inorganic acid include boric acids including tetrafluoroborate, phosphoric acid, phosphorous acid, hypophosphorous acid, carbonic acid, and silicic acid. Examples of the composite compound between an organic acid and an inorganic acid include boro-disalicylic acid, boro-dioxalic acid, and boro-diglycolic acid.

Examples of at least one salt of the salt of an organic acid, the salt of an inorganic acid, and the salt of a composite compound between an organic acid and an inorganic acid include an ammonium salt, a quaternary ammonium salt, a quaternarized amidinium salt, an amine salt, a sodium salt, and a potassium salt. Examples of a quaternary ammonium ion of the quaternary ammonium salt include tetramethylammonium, triethylmethylammonium, and tetraethylammonium. Examples of the quaternarized amidinium salt include ethyldimethylimidazolinium and tetramethylimidazolinium. Examples of an amine of the amine salt include a primary amine, a secondary amine, and a tertiary amine. Examples of the primary amine include methylamine, ethylamine, and propylamine. Examples of the secondary amine include dimethylamine, diethylamine, ethylmethylamine, and dibutylamine. Examples of the tertiary amine include trimethylamine, triethylamine, tripropylamine, tributylamine, ethyldimethylamine, and ethyldiisopropylamine. Examples of the ionic salt for an electric double-layer capacitor include a salt having the cationic component, which constitutes the plastic crystal, of the chemical formulas (N), (P), (Q), and (R).

(Manufacturing Method)

An example of a method of manufacturing the solid electrolyte containing such a plastic crystal is as follows. Each of an alkali metal salt of a first type of anion and a halogenated cation that are to constitute the plastic crystal is dissolved in a solvent. Examples of the alkali metal include Na, K, Li, and Cs. Examples of the halogen include F, Cl, Br, and I. The solvent is preferably water. Into the solution of the halogenated cation, the solution of the metal salt of the anion is gradually dropped to perform an ion-exchange reaction. An equivalent amount of moles of the solution of the metal salt of the anion is added into the solution of the halogenated cation, and the mixture is stirred.

In this time, a plastic crystal containing the first type of anion is generated and a halogenated alkali metal is generated by the ion-exchange reaction. Since the plastic crystal is hydrophobic and the halogenated alkali metal is hydrophilic, the plastic crystal is present as a solid state in the aqueous solution and the halogenated alkali metal is dissolved in the aqueous solution. With this aqueous solution in which the plastic crystal is present in the solid state, an organic solvent such as dichloromethane is mixed. The organic solvent such as dichloromethane is mixed and left to stand, and the mixed liquid is separated into an aqueous layer and an organic solvent layer.

The aqueous layer is removed from the separated liquid to remove the halogenated alkali metal. This procedure is repeated a plurality of times such as five times. The halogenated alkali metal is removed by this procedure, and then the organic solvent such as dichloromethane is evaporated to obtain the plastic crystal containing the first type of anion. When the aqueous solution is left to stand without mixing with the organic solvent such as dichloromethane, a precipitate of the plastic crystal containing the first type of anion is obtained. Thus, this precipitate may be recovered by filtering, washed with water, and the dry in vacuo.

A plastic crystal containing a second type of anion can also be obtained by the same manufacturing method as of the plastic crystal containing the first type of anion. That is, each of an alkali metal salt of the second type of anion and a halogenated cation is dissolved in a solvent, an ion-exchange reaction is performed by dropping, and an organic solvent such as dichloromethane is mixed to remove an aqueous layer.

Each of the plastic crystals containing the first and second types of anions is purified, these crystals are added into a vial bottle at a molar ratio of 1:1, and an ionic salt to be the electrolyte is further added into this vial bottle. An amount of the ionic salt is preferably 0.1 or more and 50 mol % or less relative to a total amount of the plastic crystals. Then, an organic solvent in which the plastic crystals and the electrolyte are soluble, such as acetone or acetonitrile, is further added into the vial bottle to prepare an organic solvent solution in which both of the plastic crystals and the electrolyte are dissolved.

This organic solvent solution is applied on a target of an electrode to which the solid electrolyte adheres, such as an active material layer, a separator, or both of them. After the application, the applied solution is left under a temperature environment in which the organic solvent is evaporated, such as 80° C., for drying to volatilize the solvent. Furthermore, a remained moisture and the like are volatilized under a temperature environment such as 150° C. This procedure forms the solid electrolyte on the target.

The method of manufacturing the solid electrolyte containing the plastic crystal is not limited to the above, and various methods can be used. For example, each of a powdered plastic crystal and electrolyte may be separately dissolved into an organic solvent for preparing each solution to mix these solutions. The two types of plastic crystal may be separately dissolved in the organic solvent, and the two types of plastic crystal may be dissolved in the organic solvent at the same time. In addition, a powdered plastic crystal may be dissolved in the organic solvent, and then the electrolyte may be added into the organic solvent. The electrolyte may be dissolved in the organic solvent, and then a powdered plastic crystal may be dissolved in the organic solvent. Thereafter, this organic solvent is applied on the target.

(Power Storage Device)

The power storage device is produced by disposing positive and negative electrodes opposite to each other with sandwiching the solid electrolyte. In order to prevent contact between the positive and negative electrodes and maintain the form of the solid electrolyte, a separator is interposed between the positive and negative electrodes. When the solid electrolyte has a thickness that can prevent the contact between the positive and negative electrodes and has a hardness that can maintain the form by itself, the device may be a so-called separator-less device.

Positive and negative electrodes of the electric double-layer capacitor are produced by forming an active material layer on a current collector. For the current collector, a metal having a valve action, such as aluminum foil, platinum, gold, nickel, titanium, steel, and carbon, can be used. Any shape of the current collector, such as film, foil, plate, web, expand metal, and cylinder, may be used. A surface of the current collector may have a roughness surface formed by etching treatment and the like, and may be a plain surface. A surface treatment may be performed to adhere phosphorus on the surface of the current collector.

At least one of the positive electrode and the negative electrode is a polarizable electrode. An active material layer of the polarizable electrode contains a porous-structured carbon material having an electric double-layer capacity. For the electric double-layer capacitor having the porous-structured active material layer, the solid electrolyte using this plastic crystal is particularly preferable. Since being soluble, the plastic crystal easily permeates into the porous structure to increase a filling rate into the active material layer. Meanwhile, a sulfide- and oxide-type solid electrolytes have lower filling property into the porous structure. Thus, the electric double-layer capacitor using this plastic crystal can achieve both of the good filling property into the porous structure and the high ion conductivity, and thereby has a large capacity and high output. In any other of the positive electrode and the negative electrode, an active material layer containing metal compound particles or carbon material that proceeds a Faraday reaction may be formed.

The carbon material in the polarizable electrode is mixed with a conductive auxiliary and a binder to be applied on the current collector with a doctor blade method or the like. A mixture of the carbon material, the conductive auxiliary, and the binder may be formed into a sheet to be crimped on the current collector. When the carbon material has a particle shape, the porous structure is composed of gaps generated between primary particles and between secondary particles. When the carbon material is fibric, the porous structure is composed of gaps between the fibers.

Examples of the carbon material in the active material layer of the polarizable electrode include natural plant tissues such as a coconut shell, synthetic resins such as phenol, active carbons made from a raw material derived from fossil fuel such as coal, coke, and pitch, carbon blacks such as Ketjenblack, acetylene black, and channel black, carbon nanohorn, amorphous carbon, natural graphite, artificial graphite, graphitized Ketjenblack, mesoporous carbon, carbon nanotube, and carbon nanofiber. A specific surface area of this carbon material may be increased by an activation treatment such as steam activation, alkaline activation, zinc-chloride activation, and electric field activation, and by an opening treatment.

Examples of the binder include: rubbers such as fluorine rubber, diene rubber, and styrene rubber; fluorine-containing polymers such as polytetrafluoroethylene and polyvinylidene fluoride; celluloses such as carboxymethylcellulose and nitrocellulose; and other materials such as a polyolefin resin, a polyimide resin, an acrylic resin, a nitrile resin, a polyester resin, a phenolic resin, a polyvinyl acetate resin, a polyvinyl alcohol resin, and an epoxy resin. These binders may be used singly, and may be used with mixing two or more thereof.

For the conductive auxiliary, Ketjenblack, acetylene black, natural or artificial graphite, fibric carbon, and the like can be used, and examples of the fibric carbon include fibric carbons such as carbon nanotube and carbon nanofiber (hereinafter, CNF). The carbon nanotube may be single-wall carbon nanotube (SWCNT), which has one layer of graphene sheet, may be multi-wall carbon nanotube (MWCNT), which has two or more layers of graphene sheet coaxially round to from a multilayered tube wall, and may be a mixture thereof.

A carbon-coating layer containing a conductive agent such as graphite may be provided between the current collector and the active material layer. The carbon-coating layer may be formed by applying a slurry containing the conductive agent such as graphite, a binder, and the like on the surface of the current collector to be dried.

Positive and negative electrodes of a lithium-ion secondary battery is produced by forming an active material layer on a current collector. As the current collector, metals such as aluminum foil, platinum, gold, nickel, titanium, and steel; carbon; conductive polymer materials such as polyaniline, polypyrrole, polythiophene, polyacetylene, polyparaphenylene, polyphenylenevinylene, polyacrylonitrile, and polyoxadiazole; or resins in which a non-conductive polymer material is filled with a conductive filler can be used. Any shape of the current collector, such as film, foil, plate, web, expand metal, and cylinder, may be used.

The active material is mixed with the binder to be applied on the current collector with a doctor blade method or the like. A mixture of the carbon material and the binder may be formed into a sheet to be crimped on the current collector. Into the active material layer, a conductive carbon to be a conductive auxiliary such as carbon black, acetylene black, Ketjenblack, and graphite may be added. The conductive auxiliary is kneaded in addition to the active material and the binder to be applied or crimped on the current collector.

Examples of an active material of the positive electrode include metal compound particles that can occlude and release lithium ions, and include layered rock-salt LiMO₂, a layered solid solution of Li₂MnO₃-LiMO₂, and spinel LiM₂O₄ (in the formulas, M means Mn, Fe, Co, Ni, or a combination thereof). Specific examples thereof include LiCoO₂, LiNiO₂, LiNi_{4/5}Co_{1/5}O₂, LiNi_{1/3}Co_{1/3}Mn_{1/3}O₂, LiNi_{1/2}Mn_{1/2}O₂, LiFeO₂, LiMnO₂, Li₂MnO₃—LiCoO₂, Li₂MnO₃—LiNiO₂ Li₂MnO₃—LiNi_{1/3}Co_{1/3}Mn_{1/3}O₂, Li₂MnO₃—LiNi_{1/2}Mn_{1/2}O₂, Li₂MnO₃—LiNi_{1/2}Mn_{1/2}O₂—LiNi_{1/3}Co_{1/3}Mn_{1/3}O₂, LiMn₂O₄, and LiMn_{3/2}Ni_{1/2}O₄. Examples of the metal compound particles include: sulfur; sulfides such as Li₂S, TiS₂, MoS₂, FeS₂, VS₂, and Cr_{1/2}V_{1/2}S₂; selenides such as NbSe₃, VSe₂, and NbSe₃; oxides such as Cr₂O₅, Cr₃O₈, VO₂, V₃O₈, V₂O₅, and V₆O₁₃; and in addition, composite oxides such as LiNi_{0.8}Co_{0.15}Al_{0.05}O₂, LiVOPO₄, LiV₃O₅, LiV₃O₈, MoV₂O₈, Li₂FeSiO₄, Li₂MnSiO₄, LiFePO₄, LiFe_{1/2}Mn_{1/2}PO₄, LiMnPO₄, and Li₃V₂ (PO₄)₃.

Examples of an active material of the negative electrode include metal compound particles that can occlude and release lithium ions, and include: oxides such as FeO, Fe₂O₃, Fe₃O₄, MnO, MnO₂, Mn₂O₃, Mn₃O₄, CoO, Co₃O₄, NiO, Ni₂O₃, TiO, TiO₂, TiO₂(B), CuO, NiO, SnO, SnO₂, SiO₂, RuO₂, WO, WO₂, WO₃, MoO₃, and ZnO; metals such as Sn, Si, Al, and Zn; composite oxides such as LiVO₂, Li₃Vo₄, Li₄Ti₅O₁₂, Sc₂TiO₅, and Fe₂TiO₅; nitrides such as Li_{2.6}Co_{0.4}N, Ge₃N₄, Zn₃N₂, and Cu₃N; Y₂Ti₂O₅S₂; and MoS₂.

When the separator is used in the power storage device, examples of the separator include celluloses such as kraft, Manila hemp, esparto, hemp, and rayon, and a mixed paper thereof, polyester resins such as polyethylene terephthalate, polybutylene terephthalate, and polyethylene napthalate, and a derivative thereof, a polytetrafluoroethylene resin, a polyvinylidene fluoride resin, a vinylon resin, polyamide resins such as an aliphatic polyamide, a semi-aromatic polyamide, and a wholly aromatic polyamide resin, a polyimide resin, a polyethylene resin, a polypropylene resin, a trimethylpentene resin, a polyphenylene sulfide resin, and an acrylic resin. These resins may be used singly or with mixed.

For such a power storage device, the plastic crystal and the ionic salt are dissolved in a solvent such as, for example, acetonitrile to be applied on the active material layer and the separator. After the application, the applied film is left under a temperature environment at, such as, 80° C. for drying to volatilize the solvent. Then, the active material layers of the positive and negative electrodes are disposed opposite to each other with the separator interposed therebetween, and thereafter a remained moisture and the like are volatilized under a temperature environment of, for example, 150° C. Lead electrode terminals are connected with the current collectors of the positive and negative electrodes, and sealed with an exterior housing case to produce the power storage device.

### EXAMPLES

### Examples 1 to 5

A plastic crystal containing two types of quaternary ammonium as cations was used to produce solid electrolytes for an electric double-layer capacitor of Examples 1 to 5. Ion conductivity of the solid electrolytes of Examples 1 to 5 was measured.

The solid electrolyte of Example 1 contains N-ethyl-N-methylpyrrolidinium (P12), which is a five-membered ring pyrrolidinium, as the first type of quaternary ammonium. The solid electrolyte of Example 1 also contains spiro-pyrrolidinium (SBP) as the second type of quaternary ammonium. The P12 cation and the SBP cation are contained in the plastic crystal at a molar ratio of 1:1.

The solid electrolyte of Example 2 contains N-isopropyl-N-methylpyrrolidinium (P13iso), which is a five-membered ring pyrrolidinium, as the first type of quaternary ammonium. The solid electrolyte of Example 1 also contains spiro-pyrrolidinium (SBP) as the second type of quaternary ammonium. The P13iso cation and the SBP cation are contained in the plastic crystal at a molar ratio of 1:1.

The solid electrolyte of Example 3 contains N,N-diethylpyrrolidinium (P22), which is a five-membered ring pyrrolidinium, as the first type of quaternary ammonium. The solid electrolyte of Example 1 also contains spiro-pyrrolidinium (SBP) as the second type of quaternary ammonium. The P22 cation and the SBP cation are contained in the plastic crystal at a molar ratio of 1:1.

The solid electrolyte of Example 4 contains N-ethyl-N-methylpyrrolidinium (P12), which is a five-membered ring pyrrolidinium, as the first type of quaternary ammonium. The solid electrolyte of Example 1 also contains N,N-diethylpyrrolidinium (P22), which is also a five-membered ring pyrrolidinium, as the second type of quaternary ammonium. The P12 cation and the P22 cation are contained in the plastic crystal at a molar ratio of 1:1.

The solid electrolyte of Example 5 contains triethylmethylammonium (TEMA), which is a tetraalkylammonium, as the first type of quaternary ammonium. The solid electrolyte of Example 1 also contains N,N-diethylpyrrolidinium (P22), which is a five-membered ring pyrrolidinium, as the second type of quaternary ammonium. The TEMA cation and the P22 cation are contained in the plastic crystal at a molar ratio of 1:1.

A method of manufacturing the solid electrolyte of each Example is same and is as follows. First, an anion constituting the plastic crystal of each Example was N,N-hexafluoro-1,3-disulfonylamide anion (CFSA anion). That is, a plastic crystal constituted with the first type of anion and the CFSA cation and a plastic crystal constituted with the second type of anion and the CFSA cation were added into a vial bottle at a molar ratio of 1:1.

The P12CFSA plastic crystal containing the P12 cation and the CFSA anion was prepared as follows. First, an aqueous solution of a halide in which the P12 cation was halogenated with bromine Br was prepared. An aqueous solution of an alkali metal salt between the CFSA anion and lithium Li was prepared. Into the aqueous solution of the halide, the aqueous solution of the alkali metal salt was gradually dropped to perform an ion-exchange reaction. After the ion-exchange reaction, dichloromethane was mixed, an organic solvent layer was extracted from separated layers separated into an aqueous layer and the organic solvent layer, and active carbon was added to be stirred overnight. Then, a precipitate was recovered with filtration, and this precipitate was dried to obtain the plastic crystal.

The SBPCFSA plastic crystal containing the SBP cation and the CFSA anion was prepared as follows. First, an aqueous solution of a halide in which the SBP cation was halogenated with chlorine Cl was prepared. An aqueous solution of an alkali metal salt between the CFSA anion and lithium Li was prepared. Into the aqueous solution of the halide, the aqueous solution of the alkali metal salt was gradually dropped to perform an ion-exchange reaction. After the ion-exchange reaction, dichloromethane was mixed, an organic solvent layer was extracted from separated layers separated into an aqueous layer and the organic solvent layer, and active carbon was added to be stirred overnight. Then, a precipitate was recovered with filtration, and this precipitate was dried to obtain the plastic crystal.

The P13isoCFSA plastic crystal containing the P13iso cation and the CFSA anion was prepared as follows. First, an aqueous solution of a halide in which the P13iso cation was halogenated with iodine I was prepared. An aqueous solution of an alkali metal salt between the CFSA anion and lithium Li was prepared. Into the aqueous solution of the halide, the aqueous solution of the alkali metal salt was gradually dropped to perform an ion-exchange reaction. After the ion-exchange reaction, dichloromethane was mixed, an organic solvent layer was extracted from separated layers separated into an aqueous layer and the organic solvent layer, and active carbon was added to be stirred overnight. Then, a precipitate was recovered with filtration, and this precipitate was dried to obtain the plastic crystal.

The P22CFSA plastic crystal containing the P22 cation and the CFSA anion was prepared as follows. First, an aqueous solution of a halide in which the P22 cation was halogenated with iodine I was prepared. An aqueous solution of an alkali metal salt between the CFSA anion and lithium Li was prepared. Into the aqueous solution of the halide, the aqueous solution of the alkali metal salt was gradually dropped to perform an ion-exchange reaction. After the ion-exchange reaction, dichloromethane was mixed, an organic solvent layer was extracted from separated layers separated into an aqueous layer and the organic solvent layer, and active carbon was added to be stirred overnight. Then, a precipitate was recovered with filtration, and this precipitate was dried to obtain the plastic crystal.

The TEMACFSA plastic crystal containing the TEMA cation and the CFSA anion was prepared as follows. First, an aqueous solution of a halide in which the TEMA cation was halogenated with chlorine Cl was prepared. An aqueous solution of an alkali metal salt between the CFSA anion and lithium Li was prepared. Into the aqueous solution of the halide, the aqueous solution of the alkali metal salt was gradually dropped to perform an ion-exchange reaction. After the ion-exchange reaction, dichloromethane was mixed, an organic solvent layer was extracted from separated layers separated into an aqueous layer and the organic solvent layer, and active carbon was added to be stirred overnight. Then, a precipitate was recovered with filtration, and this precipitate was dried to obtain the plastic crystal.

Into the vial bottle, an electrolyte SBPBF₄ (spiro-bipyrrolidinium tetrafluoroborate, manufactured by Tokyo Chemical Industry Co., Ltd.) was further added so that the concentration was 30 mol % relative to the total of the plastic crystals, and acetonitrile (Wako Pure Chemical Industries, Ltd.) was added so that the solid content concentration of the total of the plastic crystals and the electrolyte was 10 wt %. This acetonitrile solution was dropped on a glass separator, and dried at 80° C. to evaporate acetonitrile. This evaporation procedure was repeated three times. The glass separator immersed with the solid electrolyte by this evaporation procedure was dried under a vacuum environment at 80° C. for 12 hours, further dried under a vacuum environment at 120° C. for 3 hours, and further dried under a vacuum environment at 150° C. for 2 hours for removing moisture to obtain the solid electrolyte of each Example.

Then, the ion conductivity in each Example was measured. That is, the glass separator immersed with the solid electrolyte was sandwiched with two platinum electrodes for disposing the electrodes opposite to each other with electrode pressing to assemble a bipolar sealed cell (manufactured by TOYO SYSTEM Co., LTD.). An impedance was measured, and the ion conductivity was calculated from the measurement result of the impedance and a thickness of the glass separator permeated with the solid electrolyte. The following Table 1 shows the measurement results of this ion conductivity.

TABLE 1

| | | Plastic crystal 1 | | Plastic crystal 2 | | Ion |
|---|---|---|---|---|---|---|
| | | | Ion | | Ion | conductivity |
| | | | conductivity | | conductivity | in Example |
| | Electrolyte | Type | (S/cm) | Type | (S/cm) | (S/cm) |
| Example 1 | SBPBF₄ | P12CFSA | 2.52 × 10⁻⁷ | SBPCFSA | 2.28 × 10⁻⁷ | 5.23 × 10⁻⁵ |
| Example 2 | | P13iso CFSA | 3.46 × 10⁻⁸ | SBPCFSA | 2.28 × 10⁻⁷ | 6.13 × 10⁻⁵ |
| Example 3 | | P22CFSA | 5.83 × 10⁻⁷ | SBPCFSA | 2.26 × 10⁻⁷ | 1.39 × 10⁻⁵ |
| Example 4 | | P12CFSA | 2.52 × 10⁻⁷ | P22CFSA | 5.63 × 10⁻⁷ | 2.74 × 10⁻⁶ |
| Example 5 | | TEMACFSA | 2.67 × 10⁻⁵ | P12CFSA | 2.52 × 10⁻⁷ | 9.15 × 10⁻⁶ |

Table 1 also shows ion conductivity of a solid electrolyte using each plastic crystal alone. This comparative solid electrolyte was produced under the same condition as of the solid electrolyte of each Example except for being constituted with one type of plastic crystal.

As shown in Table 1, it can be confirmed that the ion conductivity of the solid electrolyte for an electric double-layer capacitor of each Example increases at least 10 times, and at maximum more than 300 times compared with the solid electrolyte using one type of plastic crystal. From the results, the solid electrolyte using the plastic crystal containing the two types of cations selected from the group of the quaternary ammoniums has been confirmed to have increased ion conductivity.

### Example 6

A solid electrolyte for an electric double-layer capacitor of Example 6 was produced by using a plastic crystal containing two types of imidazolium as a cation. Then, ion conductivity of the solid electrolyte of Example 6 was measured. The solid electrolyte of Example 6 contains 1-ethyl-3-methylimidazolium (EMI) as the first type of imidazolium. The solid electrolyte of Example 6 also contains 1,3-dimethylimidazolium (DMI) as the second type of imidazolium. The EMI cation and the DMI cation are contained in the plastic crystal at a molar ratio of 1:1.

An anion constituting the plastic crystal of Example 6 was N,N-hexafluoro-1,3-disulfonylamide anion (CFSA anion). A method of manufacturing the solid electrolyte of Example 6 was the same condition and the same manufacturing method as in Examples 1 to 5. The first type of plastic crystal and the second type of plastic crystal were added into a vial bottle at a molar ratio of 1:1.

Then, the ion conductivity of the solid electrolyte of Example 6 was measured. The following Table 2 shows the results. The measuring method and calculating method of the ion conductivity are same as in Examples 1 to 5. Table 2 also shows ion conductivity of a solid electrolyte using each plastic crystal alone. This comparative solid electrolyte was produced under the same condition as of the solid electrolyte of each Example except for being constituted with one type of plastic crystal.

TABLE 2

| | | Plastic crystal 1 | | Plastic crystal 2 | | Ion |
|---|---|---|---|---|---|---|
| | | | Ion | | Ion | conductivity |
| | | | conductivity | | conductivity | in Example |
| | Electrolyte | Type | (S/cm) | Type | (S/cm) | (S/cm) |
| Example 6 | SBPBF₄ | EMICFSA | 5.19 × 10⁻⁴ | DMICFSA | 3.46 × 10⁻⁴ | 3.09 × 10⁻³ |

As shown in Table 2, it can be confirmed that the ion conductivity of the solid electrolyte for an electric double-layer capacitor of Example 6 increases at least 10 times or more compared with the solid electrolyte using one type of plastic crystal. From the results, the solid electrolyte using the plastic crystal containing the two types of cations selected from the group of the imidazolium has been confirmed to have increased ion conductivity.

### Examples 7 to 11

One type of cation was selected from the imidazoliums, one type of cation was selected from the quaternary ammoniums, and solid electrolytes for an electric double-layer capacitor of Examples 7 to 11 were produced by using a plastic crystal containing the two types of cations. Then, ion conductivity of the solid electrolytes of Example 7 to 11 was measured.

The solid electrolyte of Example 7 contains 1-ethyl-3-methylimidazolium (EMI) as the first type of imidazolium. The solid electrolyte of Example 7 also contains triethylmethylammonium (TEMA) as the second type of quaternary ammonium. The EMI cation and the TEMA cation are contained in the plastic crystal at a molar ratio of 1:1.

The solid electrolyte of Example 8 contains 1-ethyl-3-methylimidazolium (EMI) as the first type of imidazolium. The solid electrolyte of Example 8 also contains N-ethyl-N-methylpyrrolidinium (P12) as the second type of quaternary ammonium. The EMI cation and the P12 cation are contained in the plastic crystal at a molar ratio of 1:1.

The solid electrolyte of Example 9 contains 1-ethyl-3-methylimidazolium (EMI) as the first type of imidazolium. The solid electrolyte of Example 9 also contains spiro-pyrrolidinium (SBP) as the second type of quaternary ammonium. The EMI cation and the SBP cation are contained in the plastic crystal at a molar ratio of 1:1.

The solid electrolyte of Example 10 contains the first 1,3-dimethylimidazolium (DMI). The solid electrolyte of Example 10 also contains spiro-pyrrolidinium (SBP) as the second type of quaternary ammonium. The DMI cation and the SBP cation are contained in the plastic crystal at a molar ratio of 1:1.

The solid electrolyte of Example 11 contains 1-methyl-3-propylimidazolium (MPI) as the first type of imidazolium. The solid electrolyte of Example 11 also contains spiro-pyrrolidinium (SBP) as the second type of quaternary ammonium. The MPI cation and the SBP cation are contained in the plastic crystal at a molar ratio of 1:1.

Then, the ion conductivity of the solid electrolytes of Examples 7 to 11 was measured. The following Table 3 shows the results. The measuring method and calculating method of the ion conductivity are same as in Examples 1 to 5. Table 3 also shows ion conductivity of a solid electrolyte using each plastic crystal alone. This comparative solid electrolyte was produced under the same condition as of the solid electrolyte of each Example except for being constituted with one type of plastic crystal.

TABLE 3

| | | Plastic crystal 1 | | Plastic crystal 2 | | Ion |
|---|---|---|---|---|---|---|
| | | | Ion | | Ion | conductivity |
| | | | conductivity | | conductivity | in Example |
| | Electrolyte | Type | (S/cm) | Type | (S/cm) | (S/cm) |
| Example 7 | SBPBF₄ | EMICFSA | 5.19 × 10⁻⁴ | TEMACFSA | 2.67 × 10⁻⁸ | 7.62 × 10⁻⁴ |
| Example 8 | | EMICFSA | 5.19 × 10⁻⁴ | P12CFSA | 2.52 × 10⁻⁷ | 1.41 × 10⁻³ |
| Example 9 | | EMICFSA | 5.19 × 10⁻⁴ | SBPCFSA | 2.28 × 10⁻⁷ | 2.55 × 10⁻³ |
| Example 10 | | DMICFSA | 3.46 × 10⁻⁴ | SBPCFSA | 2.28 × 10⁻⁷ | 2.15 × 10⁻³ |
| Example 11 | | MPICFSA | 6.76 × 10⁻⁴ | SBPCFSA | 2.28 × 10⁻⁷ | 1.11 × 10⁻³ |

As shown in Table 3, it can be confirmed that the ion conductivity of the solid electrolyte for an electric double-layer capacitor of each Example is at least same as in Example 7, and increases at maximum approximately four orders of magnitude compared with the solid electrolyte using one type of plastic crystal. From the results, the solid electrolyte using the plastic crystal containing the cations each selected from the group of the imidazoliums and the group of the quaternary ammoniums has been confirmed to have increased ion conductivity.

### Example 12

A solid electrolyte for an electric double-layer capacitor of Example 12 was produced by using a plastic crystal containing two types of cations in total, that is an imidazolium and another cation. Then, ion conductivity of the solid electrolyte of Example 12 was measured. The solid electrolyte of Example 12 contains 1-ethyl-3-methylimidazolium (EMI) as the first type of imidazolium. The solid electrolyte of Example 12 also contains a tetraethylphosphonium cation (TEP), which is a phosphonium, as the second type of cation. The EMI cation and the TEP cation are contained in the plastic crystal at a molar ratio of 1:1.

An anion constituting the plastic crystal of Example 12 was N,N-hexafluoro-1,3-disulfonylamide anion (CFSA anion). A method of manufacturing the solid electrolyte of Example 12 was the same condition and the same manufacturing method as in Examples 1 to 5. The first type of plastic crystal and the second type of plastic crystal were added into a vial bottle at a molar ratio of 1:1.

Then, the ion conductivity of the solid electrolyte of Example 12 was measured. The following Table 2 shows the results. The measuring method and calculating method of the ion conductivity are same as in Examples 1 to 5. Table 4 also shows ion conductivity of a solid electrolyte using each plastic crystal alone. This comparative solid electrolyte was produced under the same condition as of the solid electrolyte of each Example except for being constituted with one type of plastic crystal.

TABLE 4

| | | Plastic crystal 1 | | Plastic crystal 2 | | Ion |
|---|---|---|---|---|---|---|
| | | | Ion | | Ion | conductivity |
| | | | conductivity | | conductivity | in Example |
| | Electrolyte | Type | (S/cm) | Type | (S/cm) | (S/cm) |
| Example 12 | SBPBF₄ | EMICFSA | 5.19 × 10⁻⁴ | TEPCFSA | 4.5 × 10⁻⁴ | 1.57 × 10⁻³ |

As shown in Table 4, it can be confirmed that the ion conductivity of the solid electrolyte for an electric double-layer capacitor of Example 6 increases at least 30 times compared with the solid electrolyte using one type of plastic crystal. From the results, the solid electrolyte even containing another cation has also been confirmed to have increased ion conductivity.

As above, the solid electrolyte using the plastic crystal containing the two or more types of cations in total, at least one of which is selected from the group of the imidazoliums and the quaternary ammoniums has been confirmed to increase the ion conductivity.

### Example 13

Two types of cations and two types of anions were combined to constitute two types of plastic crystal at a molar ratio of 1:1, and these plastic crystals were used to produce a solid electrolyte for an electric double-layer capacitor of Example 13. Then, ion conductivity of the solid electrolyte of Example 13 was measured. The solid electrolyte of Example 13 contains spiro-pyrrolidinium (SBP), which is a quaternary ammonium, as the first type of cation, and the first type of plastic crystal in which this cation and N,N-hexafluoro-1,3-disulfonylamide (CFSA) were combined was used. The solid electrolyte of Example 13 also contains N-ethyl-N-methylpyrrolidinium (P12) as the second type of cation and as the quaternary ammonium, and the second type of plastic crystal in which this cation and bis(trifluoromethanesulfonyl)amide (TFSA) were combined was used.

Then, the ion conductivity of the solid electrolyte of Example 13 was measured. The following Table 5 shows the results. The measuring method and calculating method of the ion conductivity are same as in Examples 1 to 5. Table 5 also shows ion conductivity of a solid electrolyte using each plastic crystal alone. This comparative solid electrolyte was produced under the same condition as of the solid electrolyte of each Example except for being constituted with one type of plastic crystal. For comparison, the ion conductivity of the solid electrolyte of Example 1 is further shown.

TABLE 5

| | | Plastic crystal 1 | | Plastic crystal 2 | | Ion |
|---|---|---|---|---|---|---|
| | | | Ion | | Ion | conductivity |
| | | | conductivity | | conductivity | in Example |
| | Electrolyte | Type | (S/cm) | Type | (S/cm) | (S/cm) |
| Example 13 | SBPBF₄ | SBPCFSA | 2.28 × 10⁻⁷ | P12TFSA | 3.43 × 10⁻⁴ | 5.00 × 10⁻³ |
| Example 1 | | SBPCFSA | 2.28 × 10⁻⁷ | P12CFSA | 2.52 × 10⁻⁷ | 5.23 × 10⁻⁸ |

As shown in Table 5, it can be confirmed that the ion conductivity of the solid electrolyte for an electric double-layer capacitor of Example 13 increases at least approximately 100 times, and increases at maximum 20 thousand times compared with the solid electrolyte using one type of plastic crystal. In addition, compared with the ion conductivity of the solid electrolyte of Example 1, which was same in terms of using the two types of quaternary ammonium as the cations but used one type of anion, Example 13, which used the two types of cations and the two types of anions in combination, had approximately further 100 time higher ion conductivity.

### Examples 14 to 16

Separately to Example 13, two types of cations and two types of anions were combined to constitute two types of plastic crystal at a molar ratio of 1:1, and these plastic crystals were used to produce a solid electrolyte for an electric double-layer capacitor of Example 14. The solid electrolyte of Example 14 contains spiro-pyrrolidinium (SBP), which is a quaternary ammonium, as the first type of cation, and the first type of plastic crystal in which this cation and N,N-hexafluoro-1,3-disulfonylamide (CFSA) were combined was used. The solid electrolyte of Example 14 also contains triethylmethylammonium (TEMA) as the second type of cation and as the tetraalkylammonium, and the second type of plastic crystal in which this cation and bis(trifluoromethanesulfonyl)amide (TFSA) were combined was used.

The mixture containing the TEMA cation and the TFSA anion was prepared as follows, and an addition amount is regulated to form the plastic crystal. That is, first, an aqueous solution of a halide in which the TEMA cation was halogenated with chlorine Cl was prepared. An aqueous solution of an alkali metal salt between the CFSA anion and lithium Li was prepared. Into the aqueous solution of the halide, an equivalent amount of the aqueous solution of the alkali metal salt was gradually dropped to perform an ion-exchange reaction. After the ion-exchange reaction, dichloromethane at 60 wt % relative to the total amount of the solution was mixed, an organic solvent layer was extracted from separated layers separated into an aqueous layer and the organic solvent layer, and active carbon was added to be stirred overnight. Then, a precipitate was recovered with filtration, and this precipitate was dried. This procedure yields the TEMATFSA plastic crystal. The TEMATFSA plastic crystal contains 30% or more of the TEMATFSA plastic crystal relative to a total mol % of the plastic crystal and the electrolyte to have a property as the plastic crystal.

As a comparison to Example 14, a solid electrolyte for an electric double-layer capacitor of Example 15 was produced. The solid electrolyte of Example 15 is constituted with combining two types of cations and one type of anion to contain two types of plastic crystal at a molar ratio of 1:1. The solid electrolyte of Example 15 contains spiro-pyrrolidinium (SBP), which is a quaternary ammonium, as the first type of cation, and the first type of plastic crystal in which this cation and N,N-hexafluoro-1,3-disulfonylamide (CFSA) were combined was used. The solid electrolyte of Example 15 also contains triethylmethylammonium (TEMA), which is a tetraalkylammonium, as the second type of cation and as the quaternary ammonium, and the second type of plastic crystal in which this cation and N,N-hexafluoro-1,3-disulfonylamide (CFSA) were combined was used.

Furthermore, two types of cations and two types of anions were combined to constitute two types of plastic crystal at a molar ratio of 1:1, and these plastic crystals were used to produce a solid electrolyte for an electric double-layer capacitor of Example 16. The solid electrolyte of Example 16 contains spiro-pyrrolidinium (SBP), which is a quaternary ammonium, as the first type of cation, and the first type of plastic crystal in which this cation and N,N-hexafluoro-1,3-disulfonylamide (CFSA) were combined was used. The solid electrolyte of Example 14 also contains N-ethyl-N-methylpyrrolidinium (P12), which is a five-membered ring pyrrolidinium, as the second type of cation and as the quaternary ammonium, and the second type of plastic crystal in which this cation and a bis(trifluoromethanesulfonyl)methanide anion (TFSM anion) were combined was used.

As a comparison to Example 16, a solid electrolyte for an electric double-layer capacitor of Example 1 was produced. The solid electrolyte of Example 1 is constituted with combining two types of cations and one type of anion to contain two types of plastic crystal at a molar ratio of 1:1.

Then, the ion conductivity of the solid electrolytes of Examples 14 to 16 and Example 1 was measured. The following Table 6 shows the results. The measuring method and calculating method of the ion conductivity are same as in Examples 1 to 5. Table 6 also shows ion conductivity of a solid electrolyte using each plastic crystal alone. This comparative solid electrolyte was produced under the same condition as of the solid electrolyte of each Example except for being constituted with one type of plastic crystal.

TABLE 6

| | | Plastic crystal 1 | | Plastic crystal 2 | | Ion |
|---|---|---|---|---|---|---|
| | | | Ion | | Ion | conductivity |
| | | | conductivity | | conductivity | in Example |
| | Electrolyte | Type | (S/cm) | Type | (S/cm) | (S/cm) |
| Example 14 | SBPBF₄ | SBPCFSA | 2.28 × 10⁻⁷ | TEMATFSA | 3.96 × 10⁻⁸ | 1.93 × 10⁻³ |
| Example 15 | | SBPCFSA | 2.28 × 10⁻⁷ | TEMACFSA | 2.67 × 10⁻⁸ | 1.60 × 10⁻⁶ |
| Example 16 | | SBPCFSA | 2.28 × 10⁻⁷ | P12TFSM | 1.13 × 10⁻⁹ | 8.60 × 10⁻⁴ |
| Example 1 | | SBPCFSA | 2.28 × 10⁻⁷ | P12CFSA | 2.52 × 10⁻⁷ | 5.23 × 10⁻⁵ |

As shown in Table 6, it can be confirmed that the ion conductivity of the solid electrolyte for an electric double-layer capacitor of Example 14 increases at least approximately 10 thousand times compared with the solid electrolyte using one type of plastic crystal. In addition, compared with the ion conductivity of the solid electrolyte of Example 15, which was same in terms of using the two types of quaternary ammonium as the cation but used one type of anion, Example 14, which used the two types of cations and the two types of anions in combination, had more than 1000 times higher ion conductivity.

It can be confirmed that the ion conductivity of the solid electrolyte for an electric double-layer capacitor of Example 16 increases at least approximately 76 times compared with the solid electrolyte using one type of plastic crystal. In addition, compared with the ion conductivity of the solid electrolyte of Example 1, which was same in terms of using the two types of quaternary ammoniums as the cation but used one type of anion, Example 16, which used the two types of cations and the two types of anions in combination, had more than 16 times higher ion conductivity.

As shown in the comparison between Example 14 and Example 15 and the comparison between Example 16 and Example 17, it has been confirmed that the solid electrolyte using the plastic crystal using combination of two types of anions such as, for example, two or more types of anions in total selected from the group of the amide anions in which two hydrogen atoms of an NH₂ anion are substituted with a perfluoroalkylsulfonyl group, a fluorosulfonyl group, or both of them, and a tris(trifluoromethanesulfonyl)methanide anion further increases the ion conductivity.

### Example 17

Three types of plastic crystal were used to produce a solid electrolyte for a lithium-ion secondary battery of Example 17. Then, ion conductivity of the solid electrolyte of Example 17 was measured. The solid electrolyte of Example 17 contains N-ethyl-N-methylpyrrolidinium (P12) of the pyrrolidinium, which is a five-membered ring quaternary ammonium, as the first type of cation. This cation and a bis(fluorosulfonyl)amide anion (FSA anion), which was an amide anion, were combined to use a P12FSA plastic crystal, the first type.

The solid electrolyte of Example 17 also contains triethylmethylammonium (TEMA) of the tetraalkylammonium as the second type of cation and as the quaternary ammonium. This cation and a bis(fluorosulfonyl)amide anion (FSA anion), which was an amide anion, were combined to use a TEMAFSA plastic crystal, the second type.

The solid electrolyte of Example 17 further contains N-ethyl-N-methylpyrrolidinium (P12) of the pyrrolidinium, which is a five-membered ring quaternary ammonium. Bis(trifluoromethanesulfonyl)amide (TFSA), which is an amide anion, was combined as the second type of anion to use a P12TFSA plastic crystal, the third type.

Into a vial bottle, an electrolyte LiTFSA (lithium bis(trifluoromethanesulfonyl)amine, manufactured by KISHIDA CHEMICAL CO., LTD.) was further added so that the concentration was 10 mol % relative to the total of the plastic crystals, in addition to these three types of plastic crystal. Acetonitrile (Wako Pure Chemical Industries, Ltd.) was added so that the solid content concentration of the total of the plastic crystals and the electrolyte was 10 wt %. The P12FSA plastic crystal (A), the TEMAFSA plastic crystal (B), and the P12TFSA plastic crystal (C) were added into the vial bottle at A:B:C=4:4:2.

This acetonitrile solution was dropped on a glass separator, and dried at 80° C. to evaporate acetonitrile. This evaporation procedure was repeated three times. The glass separator immersed with the solid electrolyte by this evaporation procedure was dried under a vacuum environment at 80° C. for 12 hours, further dried under a vacuum environment at 120° C. for 3 hours, and further dried under a vacuum environment at 150° C. for 2 hours for removing moisture to obtain the solid electrolyte of Example 16.

Then, ion conductivity of the solid electrolyte of Example 17 was measured. The following Table 7 shows the results. The measuring method and calculating method of the ion conductivity are same as in Examples 1 to 5. Table 7 also shows ion conductivity of a solid electrolyte using each plastic crystal alone. This comparative solid electrolyte was produced under the same condition as of the solid electrolyte of Example 17 except for being constituted with one type of plastic crystal.

TABLE 7

| | | Plastic crystal 1 | | Plastic crystal 2 | | Plastic crystal 3 | | Ion |
|---|---|---|---|---|---|---|---|---|
| | | | Ion | | Ion | | Ion | conductivity |
| | | | conductivity | | conductivity | | conductivity | in Example |
| | Electrolyte | Type | (S/cm) | Type | (S/cm) | Type | (S/cm) | (S/cm) |
| Example 17 | LiTFSA | P12FSA | 1.03 × 10⁻⁴ | TEMAFSA | 2.48 × 10⁻³ | P12TFSA | 7.00 × 10⁻⁶ | 4.24 × 10⁻² |

As shown in Table 7, it can be confirmed that the ion conductivity of the solid electrolyte for a lithium-ion secondary battery of Example 17 increases at least approximately twice, and at maximum more than 600 times compared with the solid electrolyte using one type of plastic crystal. From the results, the solid electrolyte for a lithium-ion secondary battery also has been confirmed to have increased ion conductivity.

1. A solid electrolyte, comprising a plastic crystal doped with an electrolyte, wherein
the plastic crystal contains two or more types of cations in total, at least one of which is selected from the group of imidazoliums and quaternary ammoniums.

2. The solid electrolyte according to claim 1, wherein the plastic crystal contains two types of cations selected from the group of the quaternary ammoniums.

3. The solid electrolyte according to claim 1, wherein the plastic crystal contains two types of cations selected from the group of the imidazoliums.

4. The solid electrolyte according to claim 1, wherein the plastic crystal contains: one type of cation selected from the group of the imidazoliums; and one type of cation selected from the group of the quaternary ammoniums.

5. The solid electrolyte according to claim 1, wherein the plastic crystal contains:
one type of cation selected from the group of imidazoliums and quaternary ammoniums; and
another type of cation excluding the imidazoliums and the quaternary ammoniums.

6. The solid electrolyte according to claim 1, wherein the imidazoliums are a 1,3-dialkylimidazolium or a 1,2,3-trialkylimidazolium represented by the following chemical formula (A): 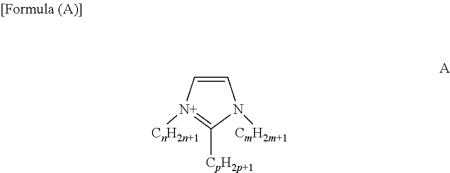
wherein n and m represent integers of 1 or more and 3 or less, and p represents 0 or 1.

7. The solid electrolyte according to claim 1, wherein the quaternary ammoniums include a tetraalkylammonium represented by the following chemical formula (B) and substituted with a linear alkyl group having any number of carbon atoms: 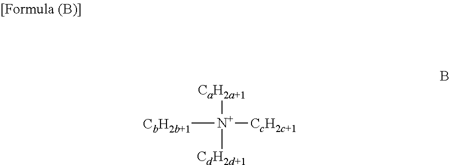
wherein a, b, c, and d represent integers of 1 or more, and the number of carbon atoms may be any number.

8. The solid electrolyte according to claim 1, wherein the quaternary ammoniums include a five-membered ring ammonium pyrrolidinium represented by the following chemical formula (C) and spiro-pyrrolidinium represented by the following chemical formula (D): 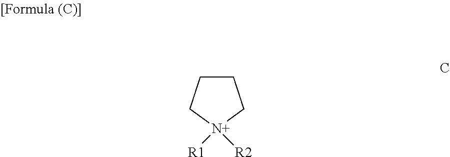
wherein R1 and R2 represent a methyl group, an ethyl group, or an isopropyl group;

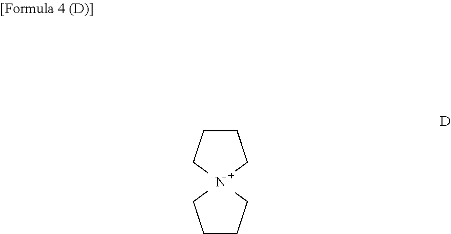

9. The solid electrolyte according to claim 5, wherein the another type of cation is one of phosphoniums represented by the following chemical formula (E): 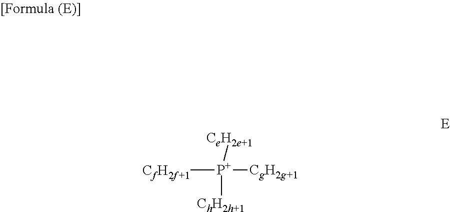
wherein e, f, g, and h represent integers of 1 or more, and the number of carbon atoms may be any number.

10. The solid electrolyte according to claim 1, wherein the plastic crystal contains two or more types of anions.

11. A power storage device, comprising:
the solid electrolyte according to claim 1; and
both electrodes disposed opposite to each other with the solid electrolyte sandwiched therebetween.

12. The power storage device according to claim 11, wherein
one or both of both the electrodes are polarizable electrode having: an active material layer composed of a porous material; and a current collector, and
an electric double layer is formed on an interface between the polarizable electrode and the solid electrolyte.

13. (canceled)

14. The solid electrolyte according to claim 2, wherein the quaternary ammoniums include a tetraalkylammonium represented by the following chemical formula (B) and substituted with a linear alkyl group having any number of carbon atoms: 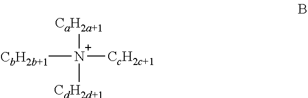
wherein a, b, c, and d represent integers of 1 or more, and the number of carbon atoms may be any number.

15. The solid electrolyte according to claim 2, wherein the quaternary ammoniums include a five-membered ring ammonium pyrrolidinium represented by the following chemical formula (C) and spiro-pyrrolidinium represented by the following chemical formula (D): 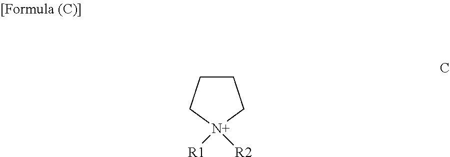
wherein R1 and R2 represent a methyl group, an ethyl group, or an isopropyl group;

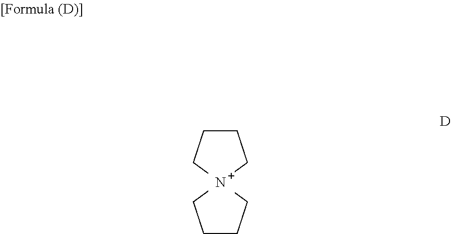

16. The solid electrolyte according to claim 3, wherein the imidazoliums are a 1,3-dialkylimidazolium or a 1,2,3-trialkylimidazolium represented by the following chemical formula (A): 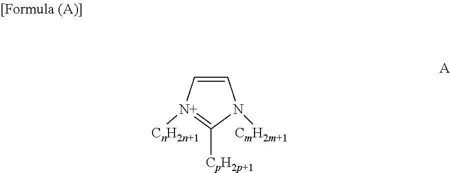
wherein n and m represent integers of 1 or more and 3 or less, and p represents 0 or 1.

17. The solid electrolyte according to claim 4, wherein the quaternary ammoniums include a tetraalkylammonium represented by the following chemical formula (B) and substituted with a linear alkyl group having any number of carbon atoms: 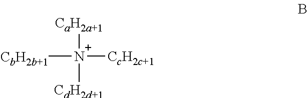
wherein a, b, c, and d represent integers of 1 or more, and the number of carbon atoms may be any number.

18. The solid electrolyte according to claim 4, wherein the quaternary ammoniums include a five-membered ring ammonium pyrrolidinium represented by the following chemical formula (C) and spiro-pyrrolidinium represented by the following chemical formula (D): 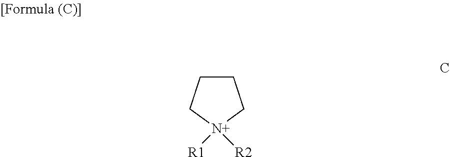
wherein R1 and R2 represent a methyl group, an ethyl group, or an isopropyl group;

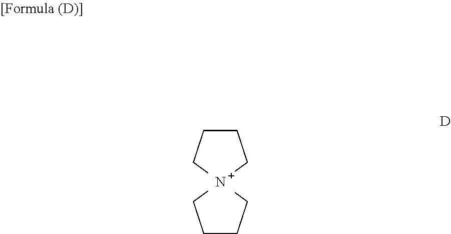

19. The solid electrolyte according to claim 2, wherein the plastic crystal contains two or more types of anions.

20. A method of manufacturing a solid electrolyte, comprising:
a step of producing a plastic crystal containing two or more types of cations at least one of which is selected from the group of imidazoliums and quaternary ammoniums.
